(19) United States
(12) Patent Application Publication
(10) Pub. No.: US 2006/0056556 A1
(43) Pub. Date: Mar. 16, 2006

(54) Method for guaranteeing an identical message sequence in serveral data sinks

(75) Inventors: Wolfgang Bachmann, Braunschweig (DE); Jorg Deister, Peine (DE); Volker Goricke, Wolfenbuttel (DE); Bernd Prade, Baddeckenstedt (DE)

Correspondence Address: MORRISON & FOERSTER LLP, 1650 TYSONS BOULEVARD, SUITE 300, MCLEAN, VA, 22102, US

(73) Assignee: SIEMENS AKTEINGESELLSCHAFT, MUNCHEN (DE)

(21) Appl. No.: 10/542,860

(22) PCT Filed: Dec. 4, 2003
(86) PCT No.: PCT/DE03/04027

§ 371 Date: Jul. 21, 2005

(51) Int. Cl. H04L 7/00

(52) U.S. Cl. 375/354

(57) ABSTRACT

The invention relates to a method for guaranteeing an identical message sequence in several data sinks, according to which several data sources transmit data messages in parallel and independently of one another to said data sinks. To guarantee an identical message sequence, according to the invention a clock-pulse generator delivers a predefined consecutive clock-pulse generator number to all data sources at constant cycle intervals, for example 50 ms, said number being transmitted together with a message counter number that is consecutive during the cycle interval and with the message content to all data sinks.

### CLAIM FOR PRIORITY

This application claims the benefit of priority to German Application No. 10302859.5 which was filed in the German language on Jan. 22, 2003, the contents of which are hereby incorporated by reference.

### TECHNICAL FIELD OF THE INVENTION

The invention relates to a method for ensuring the same order of messages in a plurality of data sinks.

### BACKGROUND OF THE INVENTION

In the case of multicomputer systems, in particular, it is necessary for the receivers, or data sinks, to receive the data messages originating from a plurality of transmitters, or data sources, in the same order. This requires a constrained synchronization of the data sinks.

### SUMMARY OF THE INVENTION

The invention discloses a method in which the data sinks are synchronized in such a way as to ensure the same message order of the data messages in different data sources.

In one embodiment of the invention, the clock generator transmits a broadcast message cyclically, for example at equidistant time intervals of 50 ms. The message comprises a consecutive clock generator number, preferably in the 32-bit format. The current clock generator number is stored in each data source. Before a message is written to the transmission buffer of the data source, this is provided with a message header comprising the current clock generator number and a consecutive message counting number within the clock cycles, preferably in the 8-bit format. As long as the clock generator number has the same value, the message counting number is increased by one upon the generation of the message header. If the data source receives a new clock generator number from the clock generator, the message counting number is reset to the initialization value. The next time a message is written to the transmission buffer, the message is in turn preceded by the current clock generator number together with the message counting number=1. On account of the items of information in the message header, namely clock generator number and message counting number, the same order of messages can be established in all the data sinks.

In another embodiment of the invention, in the data sinks, in addition to the clock generator number and the message counting number, the sender address is also used for sorting. The sorting instant is determined by the fact that a determined time on the basis of a number of clock cycles, preferably of the order of magnitude of five clock cycles, must have elapsed. This ensures that all data sinks have received at least all messages with the oldest clock generator numbers.

In still another embodiment of the invention, the cycle time of a central clock generator may be lengthened by only using the central clock generator to synchronize the clock generators assigned to each individual data source. In this case, for the sake of simplicity, the cycle time of the central clock generator is an integral multiple of the cycle time of the clock generators assigned to the data sources.

The current value of the internal clock generator of the data source is then entered in the message header.

### BRIEF DESCRIPTION OF THE DRAWINGS

The invention is explained in more detail below on the basis of exemplary embodiments and illustrations, in which:

FIG. 1 shows a schematic illustration of a communication structure.

FIG. 2 shows a message construction for ensuring the same order of messages in the case of a communication structure in accordance with FIG. 1.

### DETAILED DESCRIPTION OF THE INVENTION

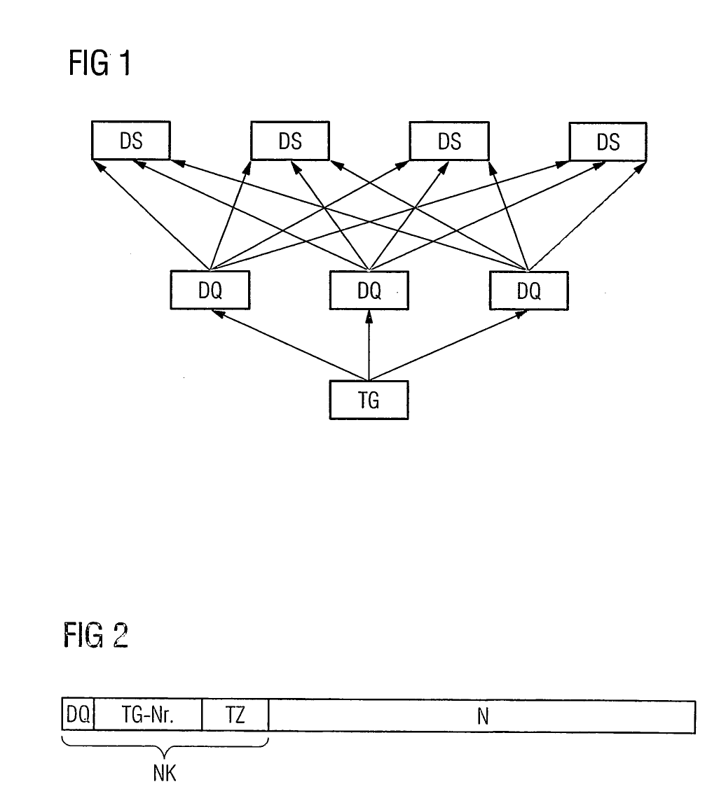

FIG. 1 shows three data sources DQ that transmit identical message contents to four data sinks DS in parallel, but independently of one another.

In order to ensure that the data messages arrive at the data sinks DS in the same order as they are generated by the data sources DQ, a special message construction is provided, which is illustrated in FIG. 2.

For this purpose, each individual message N is preceded by a message header NK. Said message header NK comprises a clock generator number TG-Nr. and a message counting number TZ. The clock generator number TG-Nr. is generated by a clock generator TG incorporated into the network and is communicated synchronously to all the data sources DQ (FIG. 1). In addition, a plurality of message counting numbers TZ, for example five in each case, are generated per clock generator number TG-Nr. When the next clock generator number TG-Nr. is present, the message counting number TZ is reset to one and restarted. In this way, the data sinks DS for which the messages N are intended are able, on the basis of the sender address, the clock generator number TG-Nr. and the message counting number TZ, to sort all incoming messages N in the same order.

The invention is not restricted to the exemplary embodiment mentioned above. Rather, a number of variants are conceivable which make use of the features of the invention even with an embodiment of a fundamentally different configuration.

1. A method for ensuring a same order of messages in a plurality of data sinks, comprising:
transmitting data messages to the data sinks in parallel and independently of one another; and
predefining in constant cycle times, for all the data sources, a consecutive clock generator number which is transmitted together with a message counting number that is consecutive during the cycle time and with the message content to the data sinks.

2. The method as claimed in claim 1, wherein the data sinks sort the received messages after the reception of a specific number of different clock generator numbers, for example five clock generator numbers, according to the clock generator number, the sender address and the message counting number.

3. The method as claimed in claims 1, further comprising synchronizing the clock generators using a central clock generator, the cycle time of which is a multiple of the cycle time of the clock generators, each data source being assigned a dedicated clock generator.
